(19) United States
(12) Patent Application Publication
(10) Pub. No.: US 2011/0135458 A1
(43) Pub. Date: Jun. 9, 2011

(54) FLUID TURBINE WITH SHROUD HAVING SEGMENTED LOBES

(76) Inventors: Walter M. Presz, JR., Wilbraham, MA (US); Michael J. Werle, West Hartford, CT (US); Robert Dold, Monson, MA (US); Timothy Hickey, Chicopee, MA (US); Thomas J. Kennedy, III, Wilbraham, MA (US)

(21) Appl. No.: 12/983,082

(22) Filed: Dec. 31, 2010

Related U.S. Application Data
(63) Continuation-in-part of application No. 12/914,509, filed on Oct. 28, 2010.
Application No. 12/914,509 is a continuation-in-part of application No. 12/054,050, filed on Mar. 24, 2008.
Application No. 12/914,509 is a continuation-in-part of application No. 12/749,341, filed on Mar. 29, 2010.
Application No. 12/749,341 is a continuation-in-part of application No. 12/054,050, filed on Mar. 24, 2008.
Application No. 12/054,050 is a continuation-in-part of application No. 12/629,714, filed on Dec. 2, 2009.
Application No. 12/629,714 is a continuation-in-part of application No. 12/425,358, filed on Apr. 16, 2009.
Application No. 12/425,358 is a continuation-in-part of application No. 12/053,695, filed on Mar. 24, 2008.
(60) Provisional application No. 61/303,339, filed on Feb. 11, 2010.
(60) Provisional application No. 61/332,722, filed on May 7, 2010.
(60) Provisional application No. 61/303,339, filed on Feb. 11, 2010.
(60) Provisional application No. 60/919,588, filed on Mar. 23, 2007.

(51) Int. Cl. F03D 5/00

(52) U.S. Cl. 415/208.1

(57) ABSTRACT

A shrouded fluid turbine comprises an impeller and a turbine shroud surrounding the impeller. The shroud includes alternating inward and outward curving elements that form mixing elements on a trailing edge of the turbine shroud. The inward and outward curving elements have exposed lateral surfaces, or in other words do not have sidewalls joining the inward and outward curving elements. This allows for both transverse mixing and radial mixing of fluid flow through the turbine shroud with fluid flow passing along the exterior of the turbine shroud.

This application is a continuation-in-part from U.S. patent application Ser. No. 12/914,509, filed on Oct. 28, 2010, which claimed priority to U.S. Provisional Patent Application Ser. No. 61/332,722 filed May 7, 2010. U.S. patent application Ser. No. 12/914,509 is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. U.S. patent application Ser. No. 12/914,509 is also a continuation-in-part from U.S. patent application Ser. No. 12/749,341, filed Mar. 29, 2010, which is a continuation-in-part of three different patent applications. First, U.S. patent application Ser. No. 12/749,341 is a continuation-in-part of U.S. patent application Ser. No. 12/054,050, filed Mar. 24, 2008, which claimed priority from U.S. Provisional Patent Application Ser. No. 60/919,588, filed Mar. 23, 2007. Second, U.S. patent application Ser. No. 12/749,341 is a continuation-in-part of U.S. patent application Ser. No. 12/629,714, filed Dec. 2, 2009, which claimed priority to U.S. Provisional Patent Application Ser. No. 61/119,078, filed Dec. 2, 2008. Third, U.S. patent application Ser. No. 12/749,341 is a continuation-in-part of U.S. patent application Ser. No. 12/425,358, filed Apr. 16, 2009, which is a continuation-in-part of two different patent applications. First, U.S. patent application Ser. No. 12/425,358 claimed priority to U.S. Provisional Patent Application Ser. No. 61/119,078, filed Dec. 2, 2008. Second, U.S. patent application Ser. No. 12/425,358 is a continuation-in-part of U.S. patent application Ser. No. 12/053,695, filed Mar. 24, 2008, which claimed priority to U.S. Provisional Patent Application Ser. No. 60/919,588, filed Mar. 23, 2007. The disclosures of each of these patent applications are hereby fully incorporated by reference in their entirety.

### BACKGROUND

The present disclosure relates to shrouded fluid turbines, wherein the turbine shroud includes inward and outward curving elements that define a trailing edge of the turbine shroud. The fluid turbines may be used to extract energy from fluids such as air (i.e. wind) or water. The aerodynamic principles of a mixer ejector wind turbine also apply to hydrodynamic principles of a mixer ejector water turbine.

Conventional horizontal axis wind turbines (HAWTs) used for power generation have two to five open blades arranged like a propeller, the blades being mounted to a horizontal shaft attached to a gear box which drives a power generator. HAWTs will not exceed the Betz limit of 59.3% efficiency in capturing the potential energy of the wind passing through it. It would be desirable to increase the efficiency of a fluid turbine by collecting additional energy from a larger volume of fluid without increasing the rotor diameter of the fluid turbine.

### BRIEF DESCRIPTION

The present disclosure relates to shrouded fluid turbines having a turbine shroud formed with both inward and outward curving elements along a trailing edge of the turbine shroud. There are no sidewalls between the inward and outward curving elements, allowing fluid flow to be mixed transversely and radially.

Disclosed in embodiments is a fluid turbine shroud, comprising a forward ring and a plurality of mixing elements. The forward ring defines a leading edge of the shroud. The plurality of mixing elements defines a trailing edge of the turbine shroud. The plurality of mixing elements comprises inward curving elements and outward curving elements configured in an alternating pattern. The inward curving elements and outward curving elements are not physically connected along the trailing edge.

Generally, each inward curving element has two exposed lateral surfaces, and wherein each outward curving element has two exposed lateral surfaces. In particular embodiments, the plurality of mixing elements has a total of nine inward curving elements and nine outward curving elements.

Optionally, the outward curving elements are wider in the circumferential direction than the inward curving elements.

In some constructions, each mixing element comprises a front end and a mixing end, and the front ends of the plurality of mixing elements form the forward ring. In addition, the front end of each mixing element may include a groove on an interior surface.

Also disclosed is a fluid turbine shroud, comprising a plurality of inward curving elements and a plurality of outward curving elements. Each inward curving element has a front end, a mixing end, and two lateral surfaces. Each outward curving element has a front end, a mixing end, and two lateral surfaces. Each inward curving element is located between two outward curving elements. Each outward curving element is located between two inward curving elements. The front ends of the inward curving elements and the front ends of the outward curving elements form a forward ring defining a leading edge of the shroud. The mixing ends of the inward curving elements and the mixing ends of the outward curving elements form a plurality of mixing elements that define a trailing edge of the shroud. The two lateral surfaces of the inward curving elements and the two lateral surfaces of the outward curving elements are exposed along the trailing edge.

Also disclosed in embodiments is a shrouded fluid turbine comprising an impeller and a turbine shroud surrounding the impeller. The turbine shroud comprises a forward ring and a plurality of mixing elements. The forward ring defines a leading edge of the shroud. The plurality of mixing elements defines a trailing edge of the turbine shroud. The plurality of mixing elements comprises inward curving elements and outward curving elements configured in an alternating pattern. Two lateral surfaces of the inward curving elements and two lateral surfaces of the outward curving elements are exposed along the trailing edge.

Each mixing element may comprise a front end and a mixing end, where the front ends of the plurality of mixing elements form the forward ring. The front end of each mixing element may also include a groove on an interior surface.

In further embodiments, the fluid turbine further comprises an ejector shroud, wherein the trailing edge of the turbine shroud extends into an inlet end of the ejector shroud.

The ejector shroud generally has the shape of a ring airfoil.

A plurality of support members may extend between the turbine shroud and the ejector shroud, each support member being aligned with an outward curving element.

In embodiments, the impeller comprises a nacelle body and a plurality of stator vanes extending between the nacelle body and the turbine shroud. In further embodiments, the nacelle body comprises a central passageway.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is an exploded perspective view of a shrouded wind turbine of the present disclosure.

FIG. 2A is a perspective view of an inward curving element.

FIG. 2B is a front view of an inward curving element.

FIG. 2C is a side view of an inward curving element.

FIG. 2D is a top view of an inward curving element.

FIG. 3A is a perspective view of an outward curving element.

FIG. 3B is a front view of an outward curving element.

FIG. 3C is a side view of an outward curving element.

FIG. 3D is a top view of an outward curving element.

FIG. 4 is a front perspective view of a second exemplary embodiment of a shrouded wind turbine of the present disclosure.

FIG. 5 is a rear perspective view of the shrouded wind turbine of FIG. 4.

FIG. 6 is a front view of the shrouded wind turbine of FIG. 4.

FIG. 7 is a rear view of the shrouded wind turbine of FIG. 4.

FIG. 8 is a side cross-sectional view of the shrouded wind turbine of FIG. 4.

FIG. 9 is a smaller view of FIG. 8.

FIG. 9A and FIG. 9B are magnified side views of the wind turbine of FIG. 8.

FIG. 10 is a front perspective view of a previously disclosed shrouded wind turbine.

FIG. 11 is a rear view of the shrouded wind turbine of FIG. 10.

FIG. 12 is a front perspective view of another shrouded wind turbine.

FIG. 13 is a rear view of the shrouded wind turbine of FIG. 12.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

A Mixer-Ejector Fluid/Water Turbine (MEWT) provides an improved means of generating power from fluid currents. A primary shroud contains an impeller which extracts power from a primary fluid stream. A mixer-ejector pump is included that ingests flow from the primary fluid stream and secondary flow, and promotes turbulent mixing of the two fluid streams. This enhances the power system by increasing the amount of fluid flow through the system, increasing the velocity at the rotor for more power availability, and reducing back pressure on turbine blades. Additional benefits include, among others, the reduction of noise propagating from the system.

The term “impeller” is used herein to refer to any assembly in which blades are attached to a shaft and able to rotate, allowing for the generation of power or energy from fluid rotating the blades. Exemplary impellers include a propeller or a rotor (which may be part of a rotor/stator assembly). Any type of impeller may be enclosed within the turbine shroud in the fluid turbine of the present disclosure.

The leading edge of a turbine shroud may be considered the front of the fluid turbine, and the trailing edge of an ejector shroud may be considered the rear of the fluid turbine. A first component of the fluid turbine located closer to the front of the turbine may be considered “upstream” of a second component located closer to the rear of the turbine. Put another way, the second component is “downstream” of the first component.

The shrouded fluid turbine of the present disclosure includes an impeller, a turbine shroud that surrounds the impeller, and an optional ejector shroud surrounding the trailing edge of the turbine shroud. Mixing elements are present on the trailing edge of the turbine shroud. In particular, the mixing elements include inward curving elements or surfaces, and outward curving elements or surfaces. Lateral surfaces on these curving elements are exposed along the trailing edge. This allows fluid passing through the turbine shroud to be mixed with fluid passing outside the turbine shroud to eventually be mixed in two directions, transversely and radially, as explained further herein. In particular, it is contemplated that the fluid turbines could be used to extract power/energy from moving air or water streams.

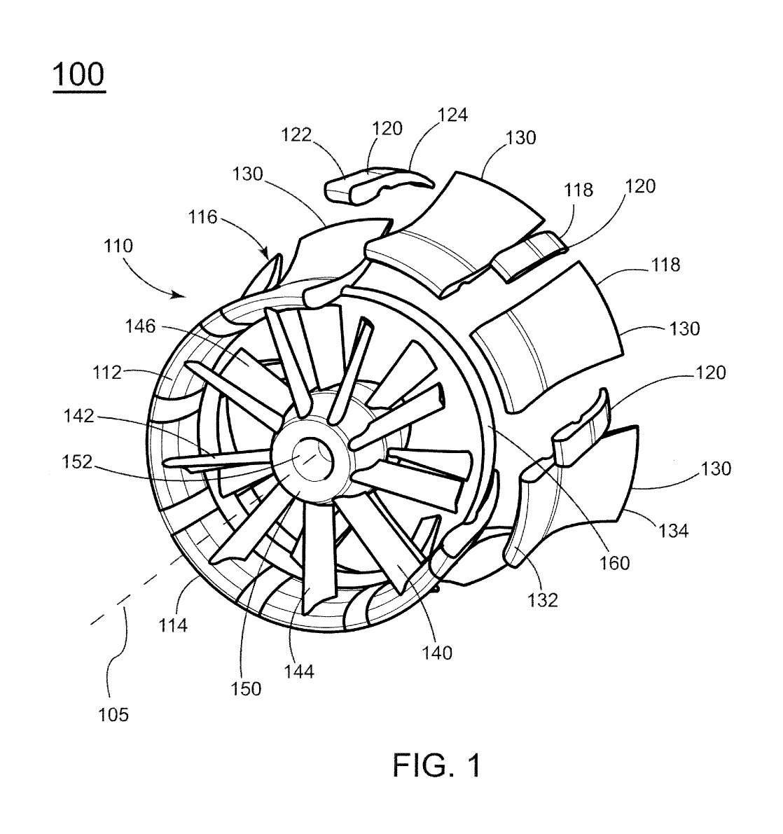

An exemplary turbine shroud is illustrated in FIG. 1 as part of a wind turbine. The wind turbine 100 comprises a turbine shroud 110. The turbine shroud has a forward ring 112 that defines a leading edge 114 of the shroud. The shroud is made up of a plurality of mixing elements 118. The mixing elements include a plurality of inward curving elements 120 and a plurality of outward curving elements 130. The terms “inward” and “outward” are relative to the central axis 105 of the turbine. As shown here, there are nine inward curving elements and nine outward curving elements. The inward curving elements 120 and outward curving elements 130 are configured in an alternating pattern. Put another way, each inward curving element 120 is located between two outward curving elements 130, and each outward curving element 130 is located between two inward curving elements 120. The mixing elements define a trailing edge 116 of the turbine shroud. It can also be seen that the inward curving elements 120 and outward curving elements 130 are not physically connected along the trailing edge 116 of the shroud. Put another way, there are no sidewalls connecting the mixing ends of the inward and outward curving elements together.

The structure of the mixing elements along the trailing edge allows fluid flowing through the interior of the turbine shroud to be mixed with fluid flowing along the exterior of the turbine shroud in two directions, radially and transversely (i.e. circumferentially). These mixing elements can also be referred to as mixing lobes. Efficiencies exceeding the Betz limit of 59.3% based on the sweep area of the rotor may be achieved.

As shown here, the mixing elements 118 also form the forward ring 112. In this regard, each inward curving element 120 can be considered as comprising a front end 122 and a mixing end 124. Similarly, each outward curving element 130 can be considered as comprising a front end 132 and a mixing end 134. The front ends 122, 124 of these mixing elements form the forward ring 112. The mixing ends 124, 134 of the mixing elements form the trailing edge 116.

The turbine shroud 110 surrounds an impeller 140. The turbine shroud also surrounds a nacelle body 150. Here, the impeller is a rotor/stator assembly. The stator 142, comprising a plurality of stator vanes 144, joins the turbine shroud 110 and the nacelle body 150. The rotor 146 rotates around the nacelle body 150 and is downstream of the stator 142. In some embodiments as depicted here, a central passageway 152 extends axially through the entirety of the nacelle body 150. The central passageway 152 allows fluid to flow through the nacelle body 150 and bypass the rotor 146 or impeller 140. This fluid is later mixed with other fluid streams to improve the efficiency of the wind turbine. A ring generator 160 converts the wind energy into electrical energy or power.

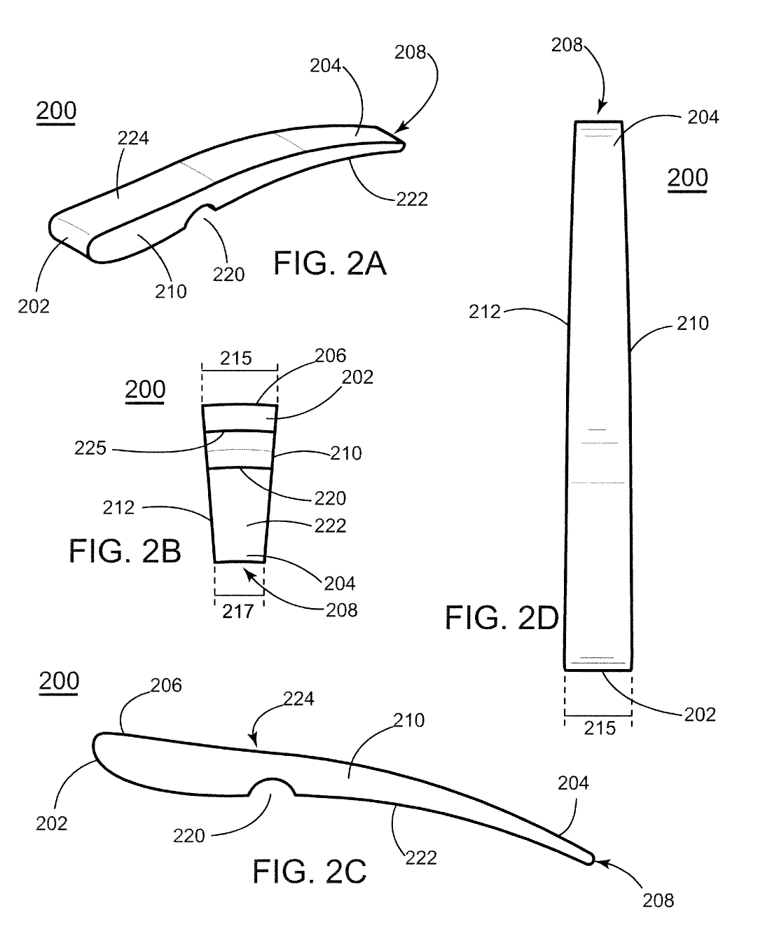

FIGS. 2A-2D show a perspective view, a front view, a side view, and a top view, respectively, of an inward curving element. The inward curving element 200 has a front end 202 and a mixing end 204. The front end 202 is located along a front edge 206, and the mixing end 204 is located along a rear edge 208 of the inward curving element. A first lateral surface 210 and a second lateral surface 212 extend between the front end 202 and the mixing end 204. The lateral surfaces curve radially inwards towards the central axis of the wind turbine, and can be described as having a cambered shape. The lateral surfaces 210, 212 are exposed along the mixing end 204 of the inward curving element. Put another way, the lateral surfaces are exposed along the trailing edge of the turbine shroud. This statement should not be construed as requiring the entirety of the lateral surface to be exposed.

From the front as seen in FIG. 2B, a curve 225 is visible, corresponding to the circumference of the forward ring. The inward curving element has a frontal width 215 in the circumferential direction along the front edge 206 and a rear width 217 in the circumferential direction along the rear edge 208. In embodiments, the frontal width 215 and the rear width 217 may be the same (i.e. equal), or the rear width 217 may be greater than the frontal width 215. From the side as seen in FIG. 2C, the front end of the curving element includes a groove 220 on an interior surface 222. Opposite the interior surface is an exterior surface 224 running from the front edge 206 to the rear edge 208. From the top as seen in FIG. 2D, the inward curving element has a rectangular shape.

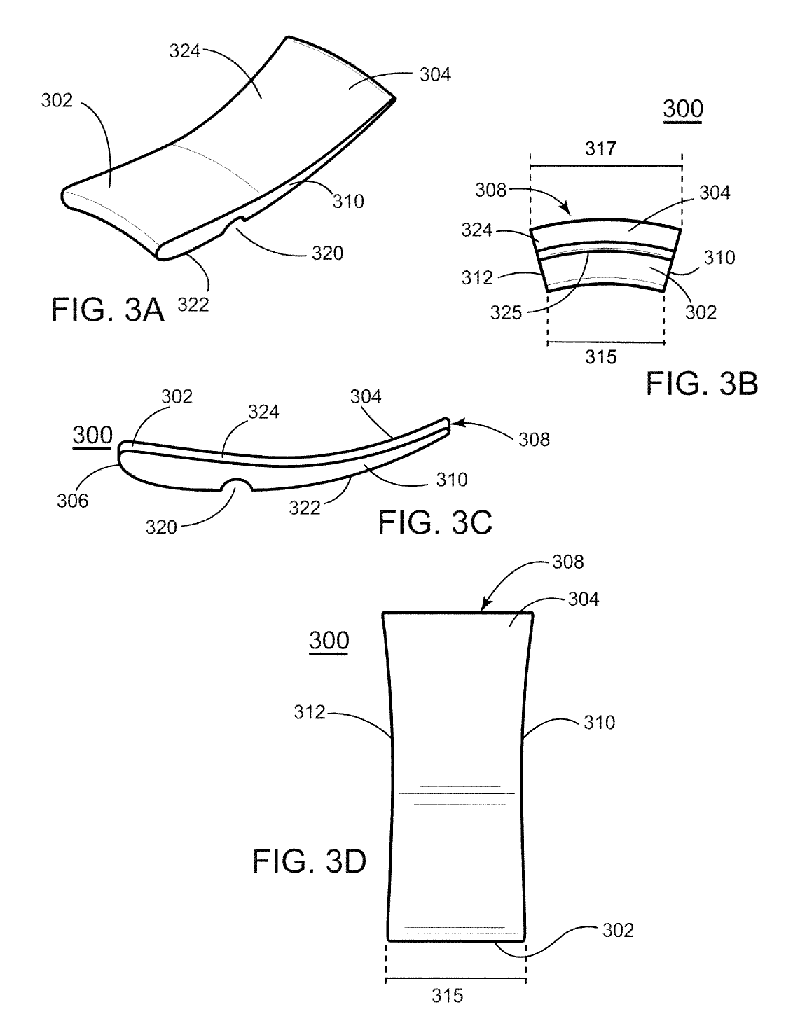

FIGS. 3A-3D show a perspective view, a front view, a side view, and a top view, respectively, of an outward curving element. The outward curving element 300 has a front end 302 and a mixing end 304. The front end 302 is located along a front edge 306, and the mixing end 304 is located along a rear edge 308 of the outward curving element. A first lateral surface 310 and a second lateral surface 312 extend between the front end 302 and the mixing end 304. The lateral surfaces curve radially outwards away from the central axis of the fluid turbine, and can be described as having a cambered shape. The lateral surfaces 310, 312 are exposed along the mixing end 304 of the outward curving element. Put another way, the lateral surfaces are exposed along the trailing edge of the turbine shroud.

From the front as seen in FIG. 3B, a curve 325 is visible, corresponding to the circumference of the forward ring. The outward curving element has a frontal width 315 in the circumferential direction along the front edge 306 and a rear width 317 in the circumferential direction along the rear edge 308. In embodiments, the frontal width 315 and the rear width 317 may be the same (i.e. equal), or the rear width 317 may be greater than the frontal width 315. From the side as seen in FIG. 3C, the front end of the curving element includes a groove 320 on an interior surface 322. Opposite the interior surface is an exterior surface 324 running from the front edge 306 to the rear edge 308. From the top as seen in FIG. 3D, the outward curving element has a rectangular shape.

The outward curving elements 300 are also wider in the circumferential direction than the inward curving elements 200. Put another way, each outward curving element has a frontal width 315, and each inward curving element has a frontal width 215, and the frontal width 315 of the outward curving elements are greater than the frontal widths 215 of the inward curving elements. All of the outward curving elements have the same frontal width 315, and all of the inward curving elements have the same frontal width 215. Similarly, the rear width 317 of the outward curving elements are greater than the rear widths 217 of the inward curving elements. All of the outward curving elements have the same rear width 317, and all of the inward curving elements have the same rear width 217.

The grooves 220, 320 in the curving elements can be used to place or locate a power or energy generation system. The grooves 220, 320 on the inward and outward curving elements are aligned with each other to form a ring when the shroud is assembled.

An inward curving element can be distinguished from an outward curving element based on their appearance from the front. As seen when comparing FIG. 2B and FIG. 3B, when facing the front edge 206 of the inward curving element 200, the rear edge 208 and the mixing end 204 are on the interior of the curve 225, or below the curve. In contrast, the rear edge 308 and the mixing end 304 of the outward curving element 300 are on the exterior of the curve 325, or above the curve. Put another way, the mixing end 204 of an inward curving element 200 is closer to the central axis than the front end 202. In contrast, the front end 302 of an outward curving element 300 is closer to the central axis than the mixing end 304.

In some embodiments, the outward curving elements are wider in the circumferential direction than the inward curving elements. In different embodiments, the inward curving elements are wider in the circumferential direction than the outward curving elements. Alternatively, the inward and outward curving elements may have the same width. The grooves on the interior surface of the curving elements can interface with, for example, a ring generator that captures energy/power from the fluid.

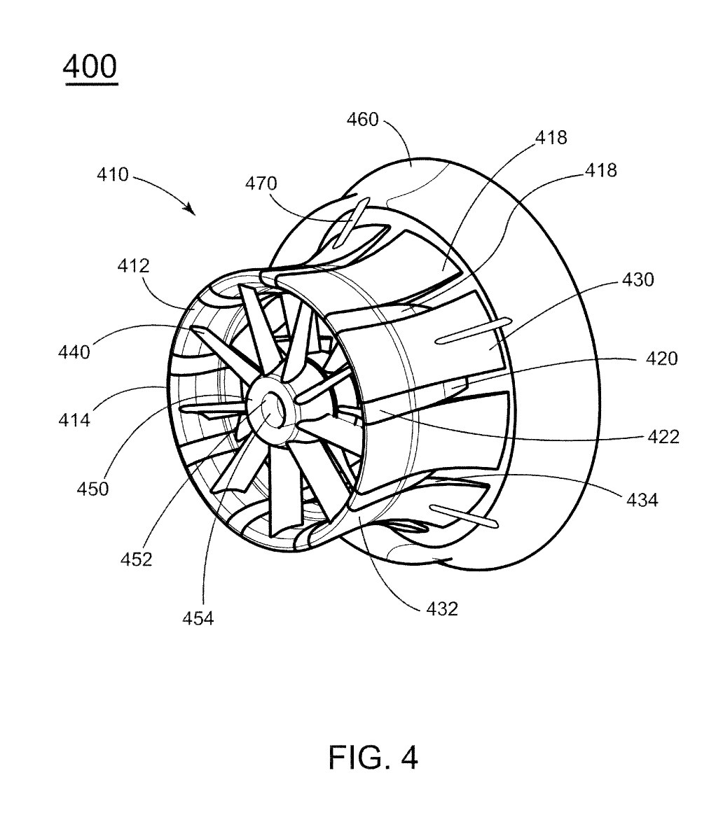

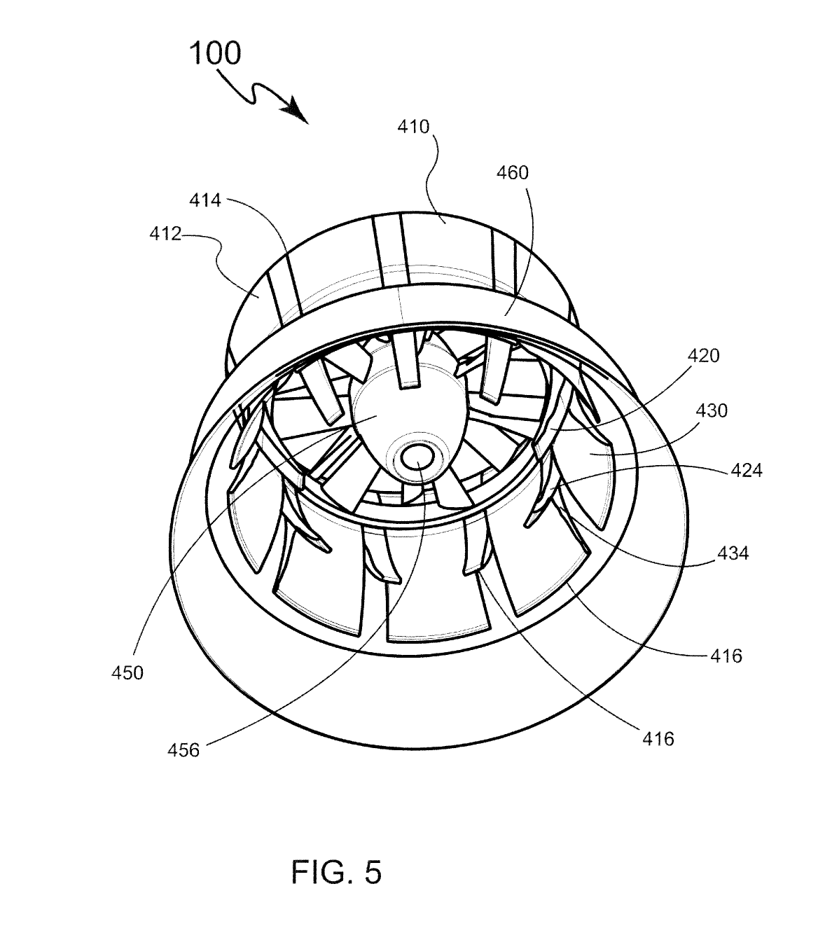

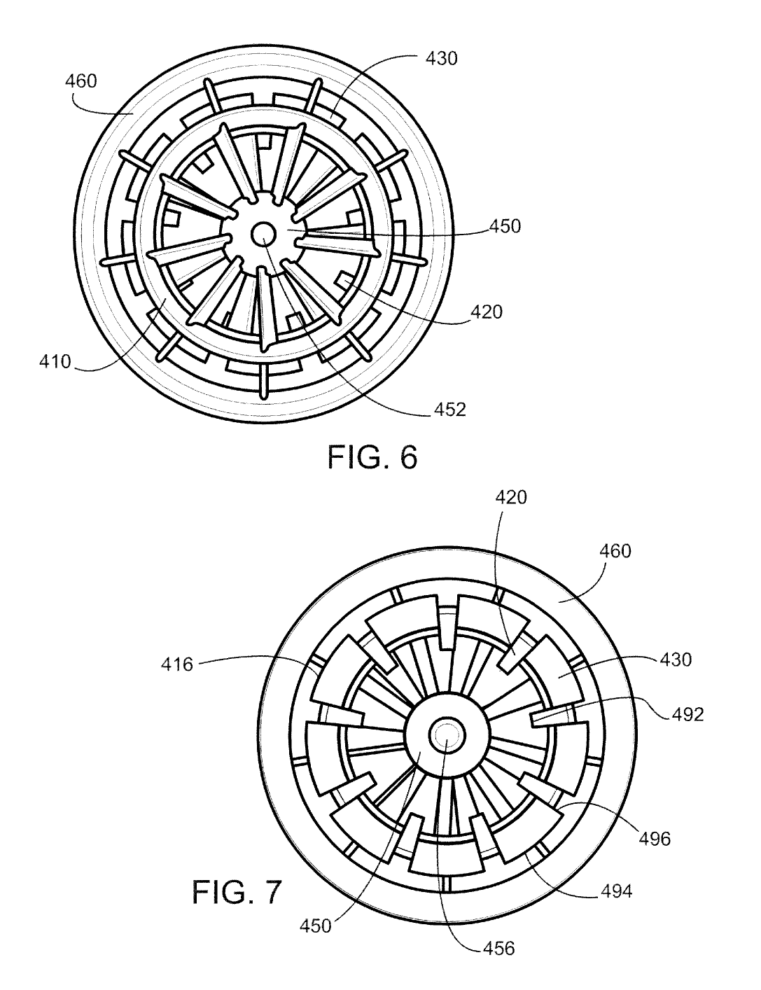

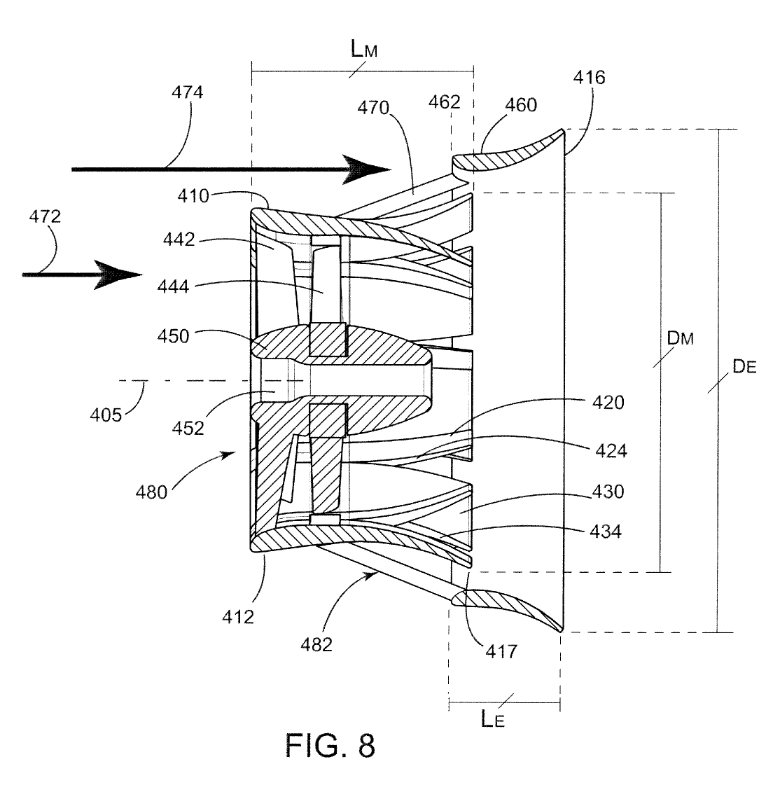

FIGS. 4-8 are various views of a second embodiment of a wind turbine 400 with a segmented turbine shroud 410 and an ejector shroud 460. FIG. 4 is a left front perspective view. FIG. 5 is a left rear perspective view. FIG. 6 is a front view. FIG. 7 is a rear view. FIG. 8 is a side cross-sectional view.

Again, the shroud 410 is made up of a plurality of mixing elements 418. The mixing elements 418 include a plurality of inward curving elements 420 and a plurality of outward curving elements 430. The inward curving elements and outward curving elements are configured in an alternating pattern. The lateral surfaces 424, 434 of the inward curving elements and outward curving elements are exposed along the trailing edge 416 of the shroud. The front ends 422, 432 of the mixing elements form the forward ring 412 at the leading edge 414 of the turbine shroud. The shroud 410 surrounds an impeller 440 and a nacelle body 450 having a central passageway 452. A first end 454 of the central passageway is visible in FIG. 4.

The wind turbine further includes an ejector shroud 460. The ejector shroud 460 has a cambered ring airfoil shape. Support members 470 join the ejector shroud 460 to the turbine shroud 410. As shown here, the support members 470 are aligned with the outward curving elements 430. However, the support members 470 could be aligned with the inward curving elements 420, or in other embodiments may be engaged with the forward ring 412 of the turbine shroud. The trailing edge 416 or the rear end 417 (see FIG. 8) of the turbine shroud 410 or the mixing lobes extend into an inlet end 462 of the ejector shroud. The ejector shroud 460, the turbine shroud 410, and the nacelle body 450 are coaxial with central axis 405.

Referring now to FIG. 5, a second end 456 of the central passageway 450 is visible here. In addition, this rear view shows that the inward curving elements 420 and the outward curving elements 430 are not physically connected along the trailing edge 416. The two lateral surfaces 424 of the inward curving elements and the two lateral surfaces 434 of the outward curving elements are exposed along the trailing edge 416.

One advantage of using mixing lobes of the shapes disclosed herein is that the axial length of the ejector shroud can be reduced. High and low energy fluid streams begin mixing at the point where the inward and outward curving elements separate, allowing for mixing to begin earlier along the axial length of the turbine than in a similar turbine without such a separation between the curving elements. Earlier mixing allows for similar overall mixing with a shorter ejector shroud. As a result, better mixing of the low energy fluid stream from the interior of the turbine shroud with the high energy fluid streams from the exterior of the turbine shroud can be achieved over a shorter axial distance. Shorter shrouds also reduce cost and weight, allowing the tower supporting the fluid turbine to also be reduced in size and weight, achieving further cost savings without sacrificing safety. In FIG. 8, the turbine shroud 410 has an axial length L_{M}, and the ejector shroud 460 has an axial length L_{E}. In embodiments, the ratio of L_{M} to L_{E} may be from

$$0.05 \leq \frac{{L}_{M}}{{L}_{E}} \leq 2.5 .$$

A segmented shroud provides a means of manufacturing identical, interchangeable, repeatable components instead of one large complicated component. A turbine shroud comprised of identical paired segments, including inwardly curving segments and outwardly curving segments as disclosed, provides ease of manufacturing by utilizing a comparatively smaller tooling repeatedly, as opposed to one large complex manufacturing method. Such segments can also be transported separately, thus allowing for segmented assembly and repair as compared to the transport, installation and maintenance of a single larger, heavier item, thus reducing the costs and complexity of moving the shrouded fluid turbine to a suitable location.

Though not shown here, the ejector shroud may also comprise segmented mixing lobes along an outlet end.

Referring now to FIG. 8, the impeller 440 surrounds the nacelle body 450. Here, the impeller is a rotor/stator assembly comprising a stator 442 having stator blades and a rotor 444 having rotor blades. The rotor is downstream and “in-line” with the stator blades. Put another way, the leading edges of the rotor blades are substantially aligned with the trailing edges of the stator blades. The rotor blades are held together by an inner ring and an outer ring (not visible). The inner ring is mounted on the nacelle body 450. The nacelle body 450 is connected to the turbine shroud 410 through the stator 442, or by other means.

The turbine shroud 410 has the cross-sectional shape of an airfoil with the suction side (i.e. low pressure side) on the interior of the shroud. The turbine shroud further comprises mixing lobes on a terminus region (i.e., end portion) of the turbine shroud. The mixing lobes extend downstream beyond the rotor blades to form the rear or downstream end 417 of the turbine shroud. The mixing lobes are formed from the inward curving elements 420 and the outward curving elements 430. Inward curving elements 420 extend inwardly towards the central axis 405 of the turbine shroud; and outward curving elements 430 extend outwardly away from the central axis. The mixing lobes extend downstream and into an inlet end 462 of the ejector shroud. Support members 470 extend axially to join the turbine shroud 410 to the ejector shroud 460.

The turbine shroud and ejector shroud are aerodynamically cambered to increase flow through the turbine rotor. The axial length of the turbine shroud L_{M} is equal or less than the turbine shroud's maximum outer diameter D_{M}. Also, the axial length of the ejector shroud L_{E} is equal or less than the ejector shroud's maximum outer diameter D_{E}. The exterior surface of the nacelle body is aerodynamically contoured to minimize the effects of flow separation downstream of the fluid turbine. The nacelle body may be configured to be longer or shorter than the turbine shroud or the ejector shroud, or their combined lengths.

The turbine shroud's entrance area and exit area will be equal to or greater than that of the annulus occupied by the impeller. The internal flow path cross-sectional area formed by the annulus between the nacelle body and the interior surface of the turbine shroud is aerodynamically shaped to have a minimum area at the plane of the turbine and to otherwise vary smoothly from their respective entrance planes to their exit planes. The cross-sectional area of the ejector shroud inlet end is greater than the cross-sectional area of the rear end of the turbine shroud.

The area ratio, as defined by the ejector shroud exit area over the turbine shroud exit area, will be in the range of 1.5-3.0. The number of each type of curving elements can be between 6 and 14. The height-to-width ratio of the lobe channels will be between 0.5 and 4.5. The lobe penetration will be between 50% and 80%. The nacelle body plug trailing edge angles will be thirty degrees or less. The length to diameter (L/D) of the overall turbine will be between 0.5 and 1.25.

Referring now to FIG. 8, free stream air (indicated generally by arrow 472) passing through the stator 442 has its energy extracted by the rotor 444. High energy air indicated by arrow 474 bypasses the turbine shroud 410 and stator 442 and flows over the exterior of the turbine shroud 410 and is directed inwardly. The mixing lobes cause the low energy air exiting downstream from the rotor to be mixed with the high energy air.

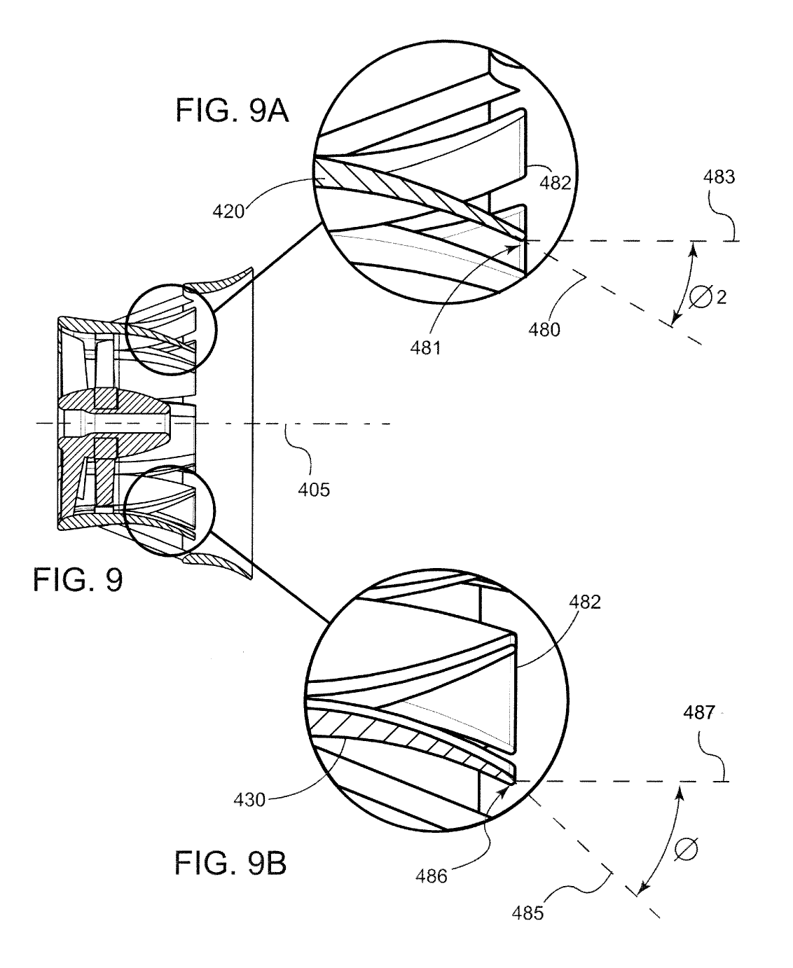

In FIG. 9A, a tangent line 480 is drawn along the interior surface at the trailing edge of the inward curving element 420. A rear plane 482 of the turbine shroud is present. The point where the tangent line 480 intersects the rear plane 482 is indicated here with reference numeral 481. A line 483 is formed at point 481 which is parallel to central axis 405. An angle Ø₂ is formed by the intersection of tangent line 480 and line 483. This angle Ø₂ is between 5 and 65 degrees. Put another way, an inward curving element forms an angle Ø₂ between 5 and 65 degrees relative to the turbine shroud.

In FIG. 9B, a tangent line 485 is drawn along the interior surface at the trailing edge of the outward curving element 430. The point where the tangent line 485 intersects the rear plane 482 is indicated here with reference numeral 486. A line 483 is formed normal to the rear plane at point 486. A line 487 is formed at point 486 which is parallel to central axis 405. An angle Ø is formed by the intersection of tangent line 485 and line 487. This angle Ø is between 5 and 65 degrees. Put another way, an inward curving element forms an angle Ø between 5 and 65 degrees relative to the turbine shroud.

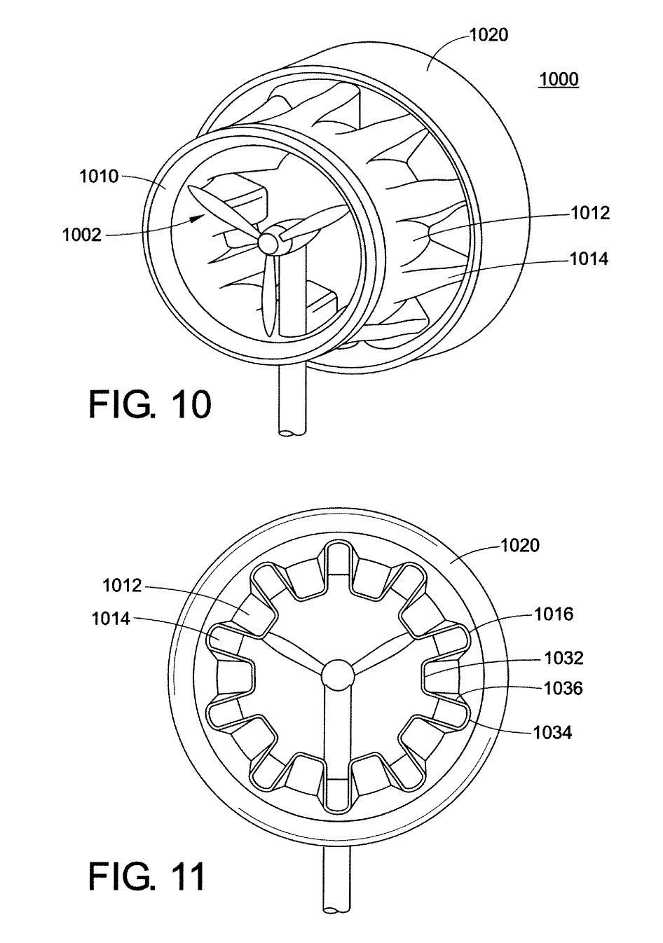

FIG. 10 and FIG. 11 are views of an embodiment of a shrouded wind turbine 1000 previously disclosed in U.S. patent application Ser. No. 12/054,050. A discussion of certain features will aid in further defining the structure of the present wind turbine.

Referring to FIG. 10, this embodiment uses a propeller-type impeller 1002 instead of a rotor/stator assembly. The turbine shroud 1010 has a set of ten high energy mixing lobes 1012 that extend inwards toward the central axis of the turbine. The turbine shroud also has a set of ten low energy mixing lobes 1014 that extend outwards away from the central axis. The high energy mixing lobes alternate with the low energy mixing lobes around the trailing edge of the turbine shroud 1010. The impeller 1002, turbine shroud 1010, and ejector shroud 1020 are coaxial with each other, i.e. they share a common central axis.

Referring now to FIG. 11, the trailing edge of the turbine shroud can be described as including a plurality of inner circumferentially spaced arcuate portions 1032 which each have the same radius of curvature. Those inner arcuate portions are evenly spaced apart from each other. Between portions 1032 are a plurality of outer arcuate portions 1034, which each have the same radius of curvature. The radius of curvature for the inner arcuate portions 1032 is different from the radius of curvature for the outer arcuate portions 1034, but the inner arcuate portions and outer arcuate portions have the same center (i.e. along the central axis). The inner portions 1032 and the outer arcuate portions 1034 are then connected to each other by radially extending portions 1036. This results in a circular crenellated shape, i.e. the general up-and-down or in-and-out shape of the trailing edge 1016. This crenellated structure forms two sets of mixing lobes, high energy mixing lobes 1012 and low energy mixing lobes 1014.

Referring now to the rear view of FIG. 7, the trailing edge 414 can also be described as including a plurality of inner circumferentially spaced arcuate portions 492 and a plurality of outer circumferentially spaced arcuate portions 494. The inner arcuate portions 492 each have the same radius of curvature, and are evenly spaced apart from each other. The outer arcuate portions 494 each have the same radius of curvature, and are evenly spaced apart from each other. The radius of curvature for the inner arcuate portions 492 is different from the radius of curvature for the outer arcuate portions 494, but the inner arcuate portions and outer arcuate portions have the same center (i.e. along the central axis 405).

However, the wind turbine of FIG. 7 differs from the wind turbine of FIG. 11 in that the mixing elements of the present turbine shroud do not include sidewalls, whereas the mixing lobes shown in FIG. 11 do include sidewalls. Put another way, the trailing edge 416 of the present segmented turbine shroud has the inner arcuate portions 492 and the outer arcuate potions 494, but does not have the radially extending portions. The portions in FIG. 7 that appear to extend radially (indicated with reference numeral 496) are actually optical illusions formed from the edges of the mixing elements, rather than being due to the presence of sidewalls. The lack of radially extending portions causes the lateral surfaces 424, 434 of the mixing elements 418 to be exposed, allowing for circumferential mixing of airflow. The trailing edge 416 can thus be described as having a circular merlonated shape (referring to the solid portions of the mixing elements) rather than a circular crenellated shape as in FIG. 11.

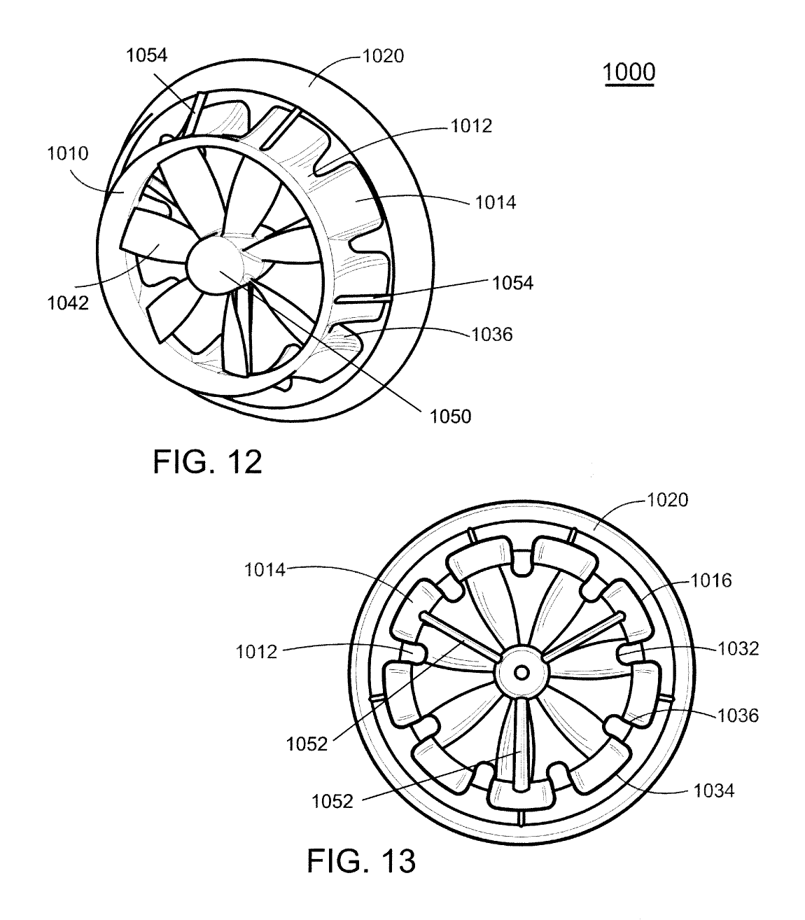

FIG. 12 and FIG. 13 are views of another embodiment of a shrouded wind turbine 1000. In this embodiment, a rotor 1042 is used instead of a propeller. The rotor 1042 engages a nacelle body 1050. The nacelle body 1050 is connected to the turbine shroud 1010 through first support members 1052. The turbine shroud 1010 is connected to the ejector shroud 1020 through second support members 1054. Also, the outer arcuate portions 1034 in FIG. 13 are longer than the inner arcuate portions 1032. In the embodiment of FIG. 11, the outer arcuate portions 1034 are shorter than the inner arcuate portions 1032. Again, the fluid turbines of the present disclosure differ from the embodiment of FIG. 12 by having exposed lateral surfaces formed from inward and outward curving elements.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A fluid turbine shroud, comprising:
a forward ring defining a leading edge of the shroud; and
a plurality of mixing elements defining a trailing edge of the turbine shroud;
wherein the plurality of mixing elements comprises inward curving elements and outward curving elements configured in an alternating pattern; and
wherein the inward curving elements and outward curving elements are not physically connected along the trailing edge.

2. The shroud of claim 1, wherein each inward curving element has two exposed lateral surfaces, and wherein each outward curving element has two exposed lateral surfaces.

3. The shroud of claim 1, wherein the plurality of mixing elements has a total of nine inward curving elements and nine outward curving elements.

4. The shroud of claim 1, wherein the outward curving elements are wider in the circumferential direction than the inward curving elements.

5. The shroud of claim 1, wherein each mixing element comprises a front end and a mixing end, and the front ends of the plurality of mixing elements form the forward ring.

6. The shroud of claim 5, wherein the front end of each mixing element includes a groove on an interior surface.

7. A fluid turbine shroud, comprising:
a plurality of inward curving elements, each inward curving element having a front end, a mixing end, and two lateral surfaces; and
a plurality of outward curving elements, each outward curving element having a front end, a mixing end, and two lateral surfaces;
wherein each inward curving element is located between two outward curving elements;
wherein each outward curving element is located between two inward curving elements;
wherein the front ends of the inward curving elements and the front ends of the outward curving elements form a forward ring defining a leading edge of the shroud;
wherein the mixing ends of the inward curving elements and the mixing ends of the outward curving elements form a plurality of mixing elements that define a trailing edge of the shroud; and
wherein the two lateral surfaces of the inward curving elements and the two lateral surfaces of the outward curving elements are exposed along the trailing edge.

8. The shroud of claim 7, wherein the plurality of mixing elements has a total of nine inward curving elements and nine outward curving elements.

9. The shroud of claim 7, wherein the outward curving elements are wider in the circumferential direction than the inward curving elements.

10. The shroud of claim 7, wherein the front end of each mixing element includes a groove on an interior surface.

11. A shrouded fluid turbine comprising an impeller and a turbine shroud surrounding the impeller, wherein the turbine shroud comprises;
a forward ring defining a leading edge of the shroud; and
a plurality of mixing elements defining a trailing edge of the turbine shroud;
wherein the plurality of mixing elements comprises inward curving elements and outward curving elements configured in an alternating pattern; and
wherein two lateral surfaces of the inward curving elements and two lateral surfaces of the outward curving elements are exposed along the trailing edge.

12. The fluid turbine of claim 11, wherein the plurality of mixing elements has a total of nine inward curving elements and nine outward curving elements.

13. The fluid turbine of claim 11, wherein the outward curving elements are wider in the circumferential direction than the inward curving elements.

14. The fluid turbine of claim 11, wherein each mixing element comprises a front end and a mixing end, and the front ends of the plurality of mixing elements form the forward ring.

15. The fluid turbine of claim 14, wherein the front end of each mixing element includes a groove on an interior surface.

16. The fluid turbine of claim 11, further comprising an ejector shroud, wherein the trailing edge of the turbine shroud extends into an inlet end of the ejector shroud.

17. The fluid turbine of claim 16, wherein the ejector shroud has the shape of a ring airfoil.

18. The fluid turbine of claim 16, further comprising a plurality of support members extending between the turbine shroud and the ejector shroud.

19. The fluid turbine of claim 16, wherein the turbine shroud has an axial length L_{M}, the ejector shroud has an axial length L_{E}, and the ratio of L_{M} to L_{E} is from 0.05 to 2.5.
